(19) United States
(12) Patent Application Publication
(10) Pub. No.: US 2026/0138053 A1
(43) Pub. Date: May 21, 2026

(54) METHOD AND SYSTEM FOR AUTOMATING SEPARATION AND PURIFICATION

(71) Applicant: Samsung Electronics Co., Ltd., Suwon-si (KR)

(72) Inventors: HYUKJU KWON, Suwon-si (KR); Dongseon Lee, Suwon-si (KR); Sooyoung Prark, Suwon-si (KR); Dongyeeb Shin, Suwon-si (KR); Seungyeon Kim, Suwon-si (KR); Jeonghun Kim, Suwon-si (KR); Jun-Won Jang, Suwon-si (KR); Hyunjeong Jeon, Suwon-si (KR); Joon-Kee Cho, Suwon-si (KR); Hyun Do Choi, Suwon-si (KR)

(73) Assignee: Samsung Electronics Co., Ltd., Suwon-si (KR)

(21) Appl. No.: 19/395,520

(22) Filed: Nov. 20, 2025

(30) Foreign Application Priority Data
Nov. 20, 2024 (KR) 10-2024-0166065

(51) Int. Cl. B01D 15/10; G01N 30/02; G01N 30/86

(52) U.S. Cl. CPC B01D 15/102; G01N 30/8675; G01N 2030/027

(57) ABSTRACT

A method and system for automating separation and purification are provided. The method includes receiving information about an objective material to be purified, confirming chemical properties of the objective material and confirming an initial separation condition, extracting a portion of a purification target material to search for a separation condition using a analysis liquid chromatography, injecting the purification target material into a purification liquid chromatography according to the searched separation condition, and separating and purifying the objective material from the purification target material injected using the purification liquid chromatography.

### CROSS-REFERENCE TO RELATED APPLICATION

This application is based on and claims priority to Korean Patent Application No. 10-2024-0166065, filed on Nov. 20, 2024, in the Korean Intellectual Property Office, the disclosure of which is incorporated by reference herein in its entirety.

### BACKGROUND

### 1. Field

The disclosure relates to a method and system for automating separation and purification of an objective material from a sample.

### 2. Description of Related Art

Purifying a specific material from a mixture may be performed by separating the mixture into a single material using various separation mechanisms, such as reverse phase, normal phase, and size exclusion, and the like, and then obtaining an objective material after detection using methods such as absorption, scattering, mass spectrometry, and the like.

Human intervention is required in the process of separating the mixture (setting separation conditions, preparing samples, injecting samples, collecting an objective material, and confirming a purity) and decisions need to be made about the analysis results. The separation and purification condition of a mixture is determined based on physicochemical properties of the objective material, and most separation conditions are determined based on researcher's experience and intuition.

Therefore, technologies of the related art have limitations in terms of operational automation and human intervention in decision making.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Provided are a method and system for automating separation and purification.

Additional aspects will be set forth in part in the description which follows and, in part, will be apparent from the description, or may be learned by practice of the presented embodiments of the disclosure.

According to an aspect of an example embodiment, a method of automating separation and purification may include receiving information about an objective material, identifying chemical properties of the objective material and identifying an initial separation condition, identifying, using an analysis liquid chromatography device, a separation condition by extracting a portion of a purification target material, injecting the purification target material into a purification liquid chromatography device according to the identified separation condition, and separating and purifying the objective material from the injected purification target material using the purification liquid chromatography device.

The method may include collecting the purified objective material and confirming a purity of the purified objective material.

The identifying the separation condition may include searching for a separation condition satisfying a preset condition by changing a combination of a type and a ratio of a solvent.

The preset condition may include the objective material being detected from the purification target material between a preset first time and a preset second time, and an interval between a detection time of a material detected before the objective material is detected and a time at which the objective material is detected being greater than a preset third time.

The identifying the separation condition may include, based on a separation condition satisfying the preset condition not being identified, determining, as the separation condition, a condition under which the objective material is detected without overlapping with other materials.

The identifying the separation condition may include, based on a separation condition satisfying the preset condition not being found and the objective material overlapping with other materials, determining, as the separation condition, a condition under which a proportion of overlapping between the objective material and the other materials is less than or equal to a preset proportion.

The identifying the separation condition may include, based on a separation condition satisfying the preset condition not being identified and a condition under which a proportion of the objective material overlapping with other materials is less than or equal to a preset proportion not being identified, determining that the separation of the objective material has failed.

The separating and purifying of the objective material from the injected purification target material may include detecting a material from the purification target material, detecting whether the detected material is the objective material, and collecting the detected material separately.

The analysis liquid chromatography device may be configured to use at least one of Liquid Chromatography-Mass Spectrometry (LC-MS), High Performance Liquid Chromatography (HPLC), Ultra Performance Liquid Chromatography (UPLC), and Gel Permeation Chromatography (GPC).

The purification liquid chromatography device may be configured to use at least one of Preparative Liquid Chromatography (Prep.LC), Medium Pressure Liquid Chromatography (MPLC), and Preparative Gel Permeation Chromatography (Prep.GPC).

According to an aspect of the disclosure, a non-transitory computer-readable storage medium may store instructions that, when executed by a processor, cause the processor to receive information about an objective material, identify chemical properties of the objective material and identifying an initial separation condition, identify, using an analysis liquid chromatography device, a separation condition by extracting a portion of a purification target material, inject the purification target material into a purification liquid chromatography device according to the identified separation condition, and separate and purify the objective material from the injected purification target material using the purification liquid chromatography device.

According to an aspect of an example embodiment, a system for automating separation and purification may include an analysis liquid chromatography device configured to identify a separation condition, a purification liquid chromatography device configured to separate and purify an objective material from a purification target material, a first input device configured to inject the purification target material into the analysis liquid chromatography device, second input device configured to inject the purification target material into the purification liquid chromatography device, and a processor configured to receive information about the objective material, identify chemical properties of the objective material to be purified and identify an initial separation condition, identify a separation condition using the analysis liquid chromatography device by extracting a portion of the purification target material with the first input device, inject, with the second input device, the purification target material into the purification liquid chromatography device according to the identified separation condition, and control to separate and purify the objective material from the purification target material injected using the purification liquid chromatography device.

The processor may be further configured to collect the purified objective material from the purification liquid chromatography device, and control to confirm a purity of the purified objective material.

The processor may be further configured to identify the separation condition by controlling to search for a separation condition satisfying a preset condition by changing a combination of a type and a ratio of a solvent.

The preset condition may include the objective material being detected from the purification target material between a preset first time and a preset second time, and an interval between a detection time of a material detected before the objective material is detected and a time at which the objective material is detected being greater than a preset third time.

The processor may be configured to identify the separation condition by, based on a separation condition satisfying the preset condition not being identified, determining, as the separation condition, a condition under which the objective material is detected without overlapping with other materials.

The processor may be further configured to identify the separation condition by, based on a separation condition satisfying the preset condition not being identified and the objective material overlapping with other materials, determining, as the separation condition, a condition under which a proportion of overlapping between the objective material and the other materials is less than or equal to a preset proportion.

The processor may be further configured to identify separation condition by, based on a separation condition satisfying the preset condition not being identified and a condition under which a proportion of the objective material overlapping with other materials is less than or equal to a preset proportion not being identified, determine that the separation of the objective material has failed.

The processor may be further configured to separate and purify the objective material by detecting a material from the purification target material, detecting whether the detected material is the objective material, and controlling to collect the detected material separately.

The analysis liquid chromatography device may be configured to use at least one of LC-MS, HPLC, UPLC, and GPC, and the purification liquid chromatography device may be configured to use at least one of Prep.LC, MPLC, and Prep.GPC.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating a configuration of an automated separation and purification system according to one or more embodiments;

FIG. 2 is a diagram illustrating a configuration of a purification liquid chromatography device of an automated separation and purification system according to one or more embodiments;

FIG. 3 is a flowchart illustrating a method of automating separation and purification according to one or more embodiments;

FIG. 4 is a flowchart illustrating a method of searching for a separation condition using a analysis liquid chromatography device according to one or more embodiments; and

FIG. 5 is a flowchart illustrating a method of searching for a next optimal separation condition according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

Hereinafter, example embodiments will be described in detail with reference to the accompanying drawings. The embodiments described below are merely exemplary, and various modifications are possible from these embodiments. In the following drawings, the same reference numerals refer to the same components, and the size of each component in the drawings may be exaggerated for clarity and convenience of description.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the components.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

The same name may be used to describe an element included in the embodiments described above and an element having a common function. Unless otherwise mentioned, the descriptions on the embodiments may be applicable to the following embodiments and thus, duplicated descriptions will be omitted for conciseness.

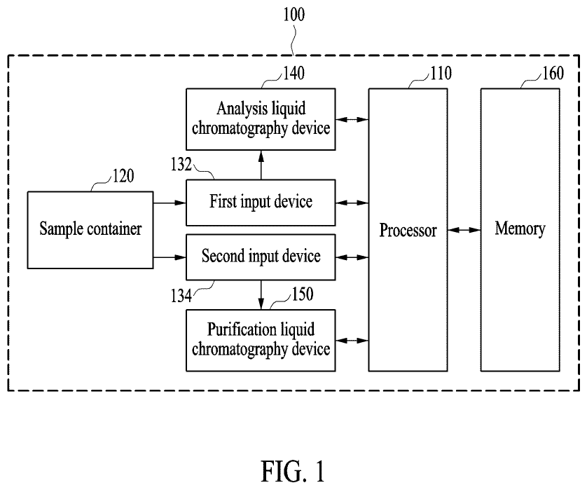

Hereinafter, a method and system for automating separation and purification according to one or more embodiments of the present disclosure will be described in detail with reference to FIGS. 1 to 5.

FIG. 1 is a diagram illustrating a configuration of an automated separation and purification system according to one or more embodiments.

Referring to FIG. 1, an automated separation and purification system 100 may include a processor 110, a memory 160, a sample container 120, a first input device 132, a second input device 134, an analysis liquid chromatography device 140, and a purification liquid chromatography device 150.

The sample container 120 may store a purification target material mixed with an objective material to be purified, and provide the purification target material to the first input device 132 and the second input device 134.

The first input device 132 may provide the purification target material stored in the sample container 120 to the analysis liquid chromatography device 140.

The second input device 134 may provide the purification target material stored in the sample container 120 to the purification liquid chromatography device 150.

The analysis liquid chromatography device 140 may perform qualitative analysis and quantitative analysis of unknown components in a mixed material, and obtain molecular weights and structural information.

The analysis liquid chromatography device 140 may use at least one of Liquid Chromatography-Mass Spectrometry (LC-MS), High Performance Liquid Chromatography (HPLC), Ultra Performance Liquid Chromatography (UPLC), and Gel Permeation Chromatography (GPC).

The purification liquid chromatography device 150 may separate and collect specific components in a mixed material.

The purification liquid chromatography device 150 may use at least one of Preparative Liquid Chromatography (Prep.LC), Medium Pressure Liquid Chromatography (MPLC), and Preparative Gel Permeation Chromatography (Prep.GPC).

The purification liquid chromatography device 150 focuses on separating and collecting specific components in a mixed solution, whereas the analysis liquid chromatography device 140 focuses on identifying and quantitatively analyzing a material. That is, the purification liquid chromatography is a technique specialized for separation, and the analysis liquid chromatography is a technique specialized for analysis.

The processor 110 may receive information about an objective material to be purified, confirm (e.g., identify) chemical properties of the objective material and confirm (e.g., identify) an initial separation condition, extract a portion of a purification target material to search (e.g., identify) for a separation condition using the analysis liquid chromatography device 140 through the first input device 132, inject the purification target material into the purification liquid chromatography device 150 according to the searched separation condition through the second input device 134, and control to separate and purify the objective material from the purification target material injected using the purification liquid chromatography device 150.

Also, the processor 110 may collect the purified objective material from the purification liquid chromatography device 150, and control to confirm a purity of the purified objective material.

When searching for the separation condition using the analysis liquid chromatography device 140, the processor 110 may control to search for the separation condition satisfying a preset condition by changing a combination of a type and a ratio of a solvent. The preset condition may be a case where the objective material is detected from the purification target material between a preset first time (e.g., 8 minutes) and a preset second time (e.g., 17 minutes) and an interval between a detection time of a material detected before the objective material is detected and a time at which the objective material is detected is greater than a preset third time (e.g., 0.1 minutes).

When searching for the separation condition using the analysis liquid chromatography device 140, when the separation condition satisfying the preset condition is not found, the processor 110 may determine a condition under which the objective material is detected without overlapping with other materials as the separation condition.

When searching for the separation condition using the analysis liquid chromatography device 140, when the separation condition satisfying the preset condition is not found and the objective material overlaps with the other materials, the processor 110 may determine a condition under which a proportion of overlapping is less than or equal to a preset proportion (e.g., 10%) as the separation condition.

When searching for the separation condition using the analysis liquid chromatography device 140, when the separation condition satisfying the preset condition is not found and a condition under which a proportion of the objective material overlapping with the other materials is less than or equal to a preset proportion is not found, the processor 110 may determine that the separation of the objective material has failed.

When separating and purifying the objective material from the purification target material injected using the purification liquid chromatography device 150, the processor 110 may detect a material from the purification target material, detect whether the detected material is the objective material, and control to collect the detected material separately.

The memory 160 may store instructions, that, when executed by the processor 110, cause the processor 110/automated separation and purification system 100 to perform the operations described herein.

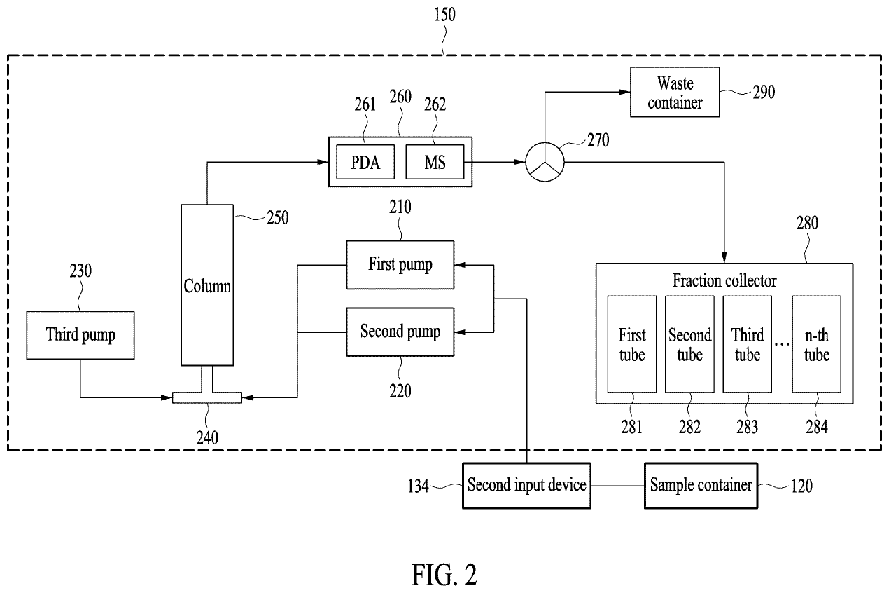

Then, an operation of the purification liquid chromatography device 150 controlled by the processor 110 will be described later with reference to FIG. 2.

FIG. 2 is a diagram illustrating a configuration of a purification liquid chromatography device of an automated separation and purification system according to one or more embodiments.

Referring to FIG. 2, the purification liquid chromatography device 150 may include a first pump 210, a second pump 220, a third pump 230, a tee union 240, a column 250, a detector 260, a classifier 270, a fraction collector 280, and a waste container 290.

The first pump 210 is a pump that supplies a large amount of sample (a portion of the purification target material) to the column 250 at a high flow rate. The first pump 210 may be configured as a preparative pump.

The second pump 220 is a pump that provides the sample to the column 250 at a flow rate less than that of the first pump 210, and may be suitable for a small amount of sample. The second pump 220 may be configured as a quaternary pump.

The third pump 230 is a pump that supplies a large amount of solvent to the column 250 at a high flow rate. The third pump 230 may be configured as a preparative pump.

The tee union 240 is a component that connects two or more pipes and may be used at a point where a mobile phase enters the column 250. In this case, the mobile phase is a solvent that moves sample components through the column.

The column 250 is a tubular pillar filled with a stationary phase. The sample components may be separated depending on a degree of interaction with the stationary phase. The stationary phase is a material filled inside the column 250, and may interact with the sample components to cause separation.

The detector 260 may detect components that pass through the column 250, and detect the objective material. The detector 260 may include a photodiode array detector (PDA) 261 and a mass spectrometer (MS) 262.

The PDA 261 may detect whether a material is present by measuring absorbance in an ultraviolet-visible light range.

The MS 262 may identify the material by measuring a molecular weight thereof.

The classifier 270 may classify the solvent and the material, transfer the solvent to the waste container 290, and transfer the material to the fraction collector 280.

The fraction collector 280 is a device that collects materials containing the objective material separated from the column 250 separately into respective test tubes.

The waste container 290 is a device that collects the solvent corresponding to the stationary phase and the mobile phase.

Hereinafter, a method according to the present disclosure configured as described above is described with reference to the drawings below.

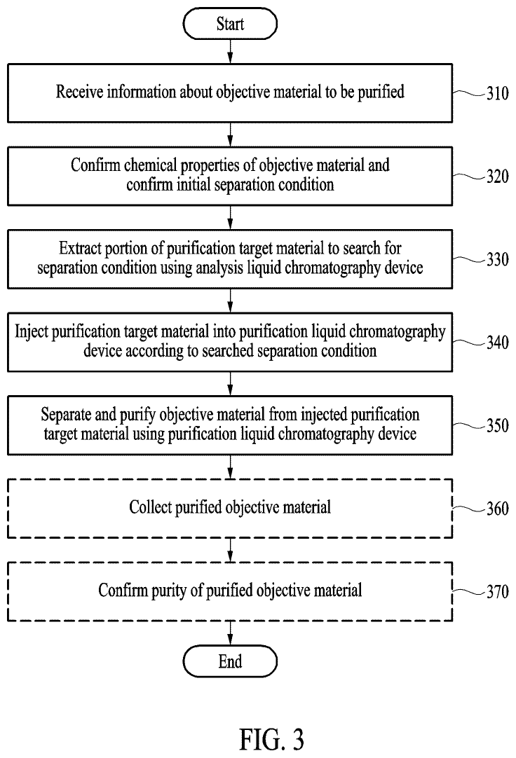

FIG. 3 is a flowchart illustrating a method of automating separation and purification according to one or more embodiments.

Referring to FIG. 3, in operation 310, the automated separation and purification system 100 may receive information about the objective material to be purified.

In operation 320, the automated separation and purification system 100 may confirm chemical properties of the objective material and confirm an initial separation condition.

In operation 330, the automated separation and purification system 100 may extract a portion of the purification target material to search for a separation condition using the analysis liquid chromatography device.

In operation 340, the automated separation and purification system 100 may inject the purification target material into the purification liquid chromatography device according to the searched separation condition.

In operation 350, the automated separation and purification system 100 may separate and purify the objective material from the purification target material injected using the purification liquid chromatography device.

In operation 360, the automated separation and purification system 100 may collect the purified objective material.

In operation 370, the automated separation and purification system 100 may confirm a purity of the purified objective material. Various operations may be reordered and/or may be optional as will be understood by one of ordinary skill in the art from the disclosure herein. For example, operations 360 and 370 may be optional and may thus be omitted.

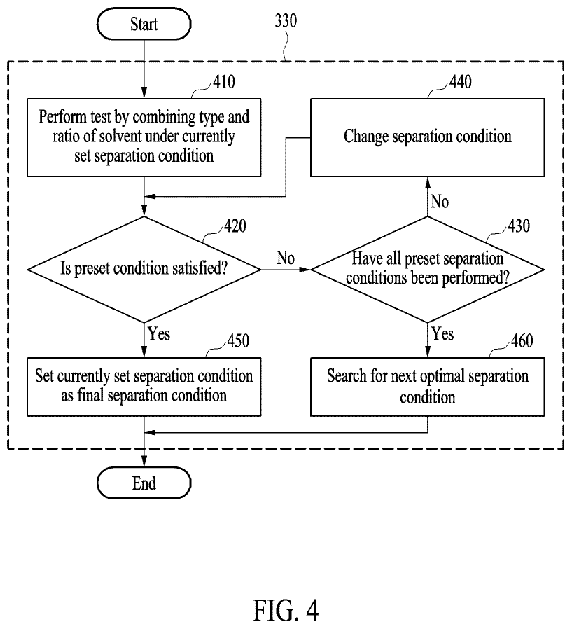

FIG. 4 is a flowchart illustrating a method of searching for a separation condition using an analysis liquid chromatography device according to one or more embodiments.

Referring to FIG. 4, in operation 410, the automated separation and purification system 100 may perform a test by combining a type and a ratio of the solvent under a currently set separation condition.

In operation 420, the automated separation and purification system 100 may confirm whether the test result satisfies a preset condition. The preset condition may be a case where the objective material is detected from the purification target material between a preset first time (e.g., 8 minutes) and a preset second time (e.g., 17 minutes) and an interval between a detection time of a material detected before the objective material is detected and a time at which the objective material is detected is greater than a preset third time (e.g., 0.1 minutes).

As a result of the confirmation in operation 420, when the preset condition is satisfied, in operation 450, the automated separation and purification system 100 may set the currently set separation condition as a final separation condition.

As a result of the confirmation in operation 420, when the preset condition is not satisfied, in operation 430, the automated separation and purification system 100 may confirm whether all of preset separation conditions have been performed.

As a result of the confirmation in operation 430, when all of the preset separation conditions have not been performed, in operation 440, the automated separation and purification system 100 may change the separation condition, and perform a test by combining the type and the ratio of the solvent under the changed separation condition. Then, the automated separation and purification system 100 may return to operation 420 and confirm again whether the preset condition is satisfied.

As a result of the confirmation in operation 430, when all of the preset separation conditions have been performed, in operation 460, the automated separation and purification system 100 may search for a next optimal separation condition.

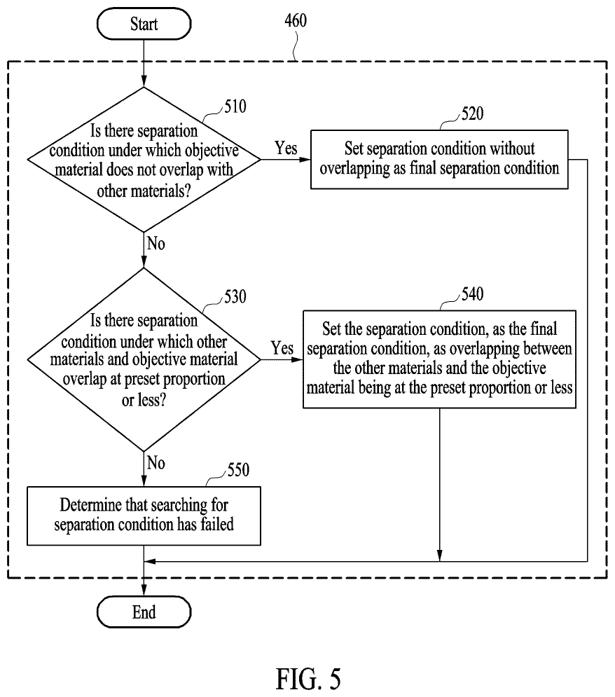

The search for the next optimal separation condition will be described later with reference to FIG. 5.

FIG. 5 is a flowchart illustrating a method of searching for the next optimal separation condition according to one or more embodiments.

Referring to FIG. 5, in operation 510, the automated separation and purification system 100 may confirm whether there is a separation condition under which the objective material does not overlap with other materials. That is, the automated separation and purification system 100 may confirm whether there is a case where a time interval between detection of the objective material and detection of other materials (a material detected immediately before the objective material or a material detected immediately after the objective material) is greater than or equal to 0.

As a result of the confirmation in operation 510, when there is the separation condition under which the objective material does not overlap with the other materials, in operation 520, the automated separation and purification system 100 may set the separation condition without overlapping as the final separation condition.

As a result of the confirmation in operation 510, when there is no separation condition under which the objective material does not overlap with the other materials, in operation 530, the automated separation and purification system 100 may confirm whether there is a separation condition under which the other materials and the objective material overlap at a preset proportion (e.g., 10%) or less.

As a result of the confirmation in operation 530, when there is the separation condition under which the other materials and the objective material overlap at the preset proportion or less, in operation 540, the automated separation and purification system 100 may set the separation condition, as the final separation condition, as overlapping between the other materials and the objective material being at the preset proportion or less.

As a result of the confirmation in operation 530, when there is no separation condition under which the other materials and the objective material overlap at the preset proportion or less, in operation 550, the automated separation and purification system 100 may determine that the searching for the separation condition has failed.

The methods according to the above-described embodiments may be recorded in non-transitory computer-readable media including program instructions to implement various operations of the above-described embodiments. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random access memory (RAM), flash memory, and the like. Examples of program instructions include both machine code, such as produced by a compiler, and files containing higher level code that may be executed by the computer using an interpreter. The devices described above may be configured to act as one or more software modules in order to perform the operations of the embodiments, or vice versa.

The software may include a computer program, a piece of code, an instruction, or some combinations thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer readable recording mediums.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

Therefore, other implementations, other embodiments, and equivalents to the claims are also within the scope of the following claims.

What is claimed is:

1. A method of automating separation and purification comprising:
receiving information about an objective material;
identifying chemical properties of the objective material and identifying an initial separation condition;
identifying, using an analysis liquid chromatography device, a separation condition by extracting a portion of a purification target material;
injecting the purification target material into a purification liquid chromatography device according to the identified separation condition; and
separating and purifying the objective material from the injected purification target material using the purification liquid chromatography device.

2. The method of claim 1, further comprising:
collecting the purified objective material; and
confirming a purity of the purified objective material.

3. The method of claim 1, wherein the identifying the separation condition comprises:
searching for a separation condition satisfying a preset condition by changing a combination of a type and a ratio of a solvent.

4. The method of claim 3, wherein the preset condition comprises the objective material being detected from the purification target material between a preset first time and a preset second time, and an interval between a detection time of a material detected before the objective material is detected and a time at which the objective material is detected being greater than a preset third time.

5. The method of claim 3, wherein the identifying the separation condition further comprises:
based on a separation condition satisfying the preset condition not being identified, determining, as the separation condition, a condition under which the objective material is detected without overlapping with other materials.

6. The method of claim 3, wherein the identifying the separation condition further comprises:
based on a separation condition satisfying the preset condition not being found and the objective material overlapping with other materials, determining, as the separation condition, a condition under which a proportion of overlapping between the objective material and the other materials is less than or equal to a preset proportion.

7. The method of claim 3, wherein the identifying the separation condition further comprises:
based on a separation condition satisfying the preset condition not being identified and a condition under which a proportion of the objective material overlapping with other materials is less than or equal to a preset proportion not being identified, determining that the separation of the objective material has failed.

8. The method of claim 1, wherein the separating and purifying of the objective material from the injected purification target material comprises:
detecting a material from the purification target material;
detecting whether the detected material is the objective material; and
collecting the detected material separately.

9. The method of claim 1, wherein the analysis liquid chromatography device is configured to use at least one of Liquid Chromatography-Mass Spectrometry (LC-MS), High Performance Liquid Chromatography (HPLC), Ultra Performance Liquid Chromatography (UPLC), and Gel Permeation Chromatography (GPC).

10. The method of claim 1, wherein the purification liquid chromatography device is configured to use at least one of Preparative Liquid Chromatography (Prep.LC), Medium Pressure Liquid Chromatography (MPLC), and Preparative Gel Permeation Chromatography (Prep.GPC).

11. A non-transitory computer-readable storage medium storing instructions that, when executed by a processor, cause the processor to:
receive information about an objective material;
identify chemical properties of the objective material and identifying an initial separation condition;
identify, using an analysis liquid chromatography device, a separation condition by extracting a portion of a purification target material;
inject the purification target material into a purification liquid chromatography device according to the identified separation condition; and
separate and purify the objective material from the injected purification target material using the purification liquid chromatography device.

12. A system for automating separation and purification, comprising:
an analysis liquid chromatography device configured to identify a separation condition;
a purification liquid chromatography device configured to separate and purify an objective material from a purification target material;
a first input device configured to inject the purification target material into the analysis liquid chromatography device;
a second input device configured to inject the purification target material into the purification liquid chromatography device; and
a processor configured to:
receive information about the objective material;
identify chemical properties of the objective material to be purified and identify an initial separation condition;
identify a separation condition using the analysis liquid chromatography device by extracting a portion of the purification target material with the first input device;
inject, with the second input device, the purification target material into the purification liquid chromatography device according to the identified separation condition; and
control to separate and purify the objective material from the purification target material injected using the purification liquid chromatography device.

13. The system of claim 12, wherein the processor is further configured to:
collect the purified objective material from the purification liquid chromatography device; and
control to confirm a purity of the purified objective material.

14. The system of claim 12, wherein the processor is further configured to identify the separation condition by:
controlling to search for a separation condition satisfying a preset condition by changing a combination of a type and a ratio of a solvent.

15. The system of claim 14, wherein the preset condition comprises the objective material being detected from the purification target material between a preset first time and a preset second time, and an interval between a detection time of a material detected before the objective material is detected and a time at which the objective material is detected being greater than a preset third time.

16. The system of claim 14, wherein the processor is configured to identify the separation condition by:
based on a separation condition satisfying the preset condition not being identified, determining, as the separation condition, a condition under which the objective material is detected without overlapping with other materials.

17. The system of claim 14, wherein the processor is further configured to identify the separation condition by:
based on a separation condition satisfying the preset condition not being identified and the objective material overlapping with other materials, determining, as the separation condition, a condition under which a proportion of overlapping between the objective material and the other materials is less than or equal to a preset proportion.

18. The system of claim 14, wherein the processor is further configured to identify separation condition by:
based on a separation condition satisfying the preset condition not being identified and a condition under which a proportion of the objective material overlapping with other materials is less than or equal to a preset proportion not being identified, determine that the separation of the objective material has failed.

19. The system of claim 12, wherein the processor is further configured to separate and purify the objective material by:
detecting a material from the purification target material;
detecting whether the detected material is the objective material; and
controlling to collect the detected material separately.

20. The system of claim 12, wherein the analysis liquid chromatography device is configured to use at least one of Liquid Chromatography-Mass Spectrometry (LC-MS), High Performance Liquid Chromatography (HPLC), Ultra Performance Liquid Chromatography (UPLC), and Gel Permeation Chromatography (GPC), and
wherein the purification liquid chromatography device is configured to use at least one of Preparative Liquid Chromatography (Prep.LC), Medium Pressure Liquid Chromatography (MPLC), and Preparative Gel Permeation Chromatography (Prep.GPC).
